(19) United States
(12) Patent Application Publication
(10) Pub. No.: US 2006/0290036 A1
(43) Pub. Date: Dec. 28, 2006

(54) Method of manufacturing honeycomb structure

(75) Inventors: Atsushi Kaneda, Ichinomiya-city (JP); Shuichi Ichikawa, Handa-city (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 11/473,108

(22) Filed: Jun. 23, 2006

(30) Foreign Application Priority Data
Jun. 27, 2005 (JP) 2005-186122

(51) Int. Cl. C04B 33/32; B28B 1/00; C04B 35/64; B28B 3/00

(52) U.S. Cl. 264/628; 264/630

(57) ABSTRACT

There is disclosed a method of manufacturing a honeycomb structure in which defects or deformations during forming can be reduced, and yield can be improved. The method of manufacturing the honeycomb structure includes the steps of mixing and kneading a clay material including a ceramic material, a binder and water to obtain a clay; forming the resultant clay into a honeycomb shape to obtain a honeycomb formed body; and firing the resultant honeycomb formed body to obtain a honeycomb structure, a material further including a water absorption resin is used as the clay material, an inorganic binder only is used as the binder included in the clay material, an organic binder is not substantially used, and the honeycomb structure having a porosity of 40% or more is obtained.

### BACKGROUND OF THE INVENTION

1. Field of the Invention

The present invention relates to a method of manufacturing a honeycomb structure for use in various types of filters or the like, and a method of manufacturing a honeycomb structure in which defects or deformations during forming can be reduced, and an amount of heat to be generated during degreasing can be reduced, so that it is possible to prevent cells from being cracked and improve yield.

2. Description of the Related Art

Among various types of filters, for example, a diesel particulate filter (DPF) is a filter for use in trapping and removing particulates included in an exhaust gas from a diesel engine or the like, and the filter is incorporated in an exhaust system of the diesel engine when used. A filter such as the DPF is prepared by bonding a plurality of honeycomb structures (honeycomb segments), the honeycomb structure being as one unit (honeycomb segment).

FIGS. 1 and 2 show the honeycomb structure as one unit (honeycomb segment) for use in such DPF. As shown in FIGS. 1 and 2, this honeycomb structure 2 is formed into a tubular shape having a square section, and contains a large number of flowing cells 5 defined by porous partition walls 6. The flowing cells 5 extend through the honeycomb structure 2 in an axial direction, and one-end portions of the adjacent flowing cells 5 are alternately plugged with a filling material 7. That is, a left end portion of each of the flowing cells 5 is opened, whereas a right end portion thereof is plugged with the filling material 7. A left end portion of another flowing cell 5 adjacent to the above cell is plugged with the filling material 7, but a right end portion thereof is opened. Such plugging allows an end of the honeycomb structure 2 to have a checkered pattern.

It is to be noted that a sectional shape of the honeycomb structure 2 may be triangular, hexagonal or the like in addition to the above square shape. The flowing cell 5 may have a sectional shape such as a triangular shape, a hexagonal shape, a circular shape or an elliptical shape.

FIG. 3 shows the DPF as the filter prepared by bonding a plurality of honeycomb structures 2 described above. As shown in FIG. 3, a DPF 1 is prepared by bonding a plurality of honeycomb structures 2 via a bonding material 9; grinding an outer periphery of a bonded article so that a sectional shape of the article is circular, elliptical, triangular or the like; and coating an outer peripheral surface with a coating material 4. When this DPF 1 is disposed in a channel of the exhaust gas of the diesel engine, it is possible to trap particulates including soot discharged from the diesel engine.

That is, in a case where the DPF 1 is disposed in the channel of the exhaust gas, the exhaust gas flows through the flowing cells 5 of each honeycomb structure 2 from the left side of FIG. 2 to the right side thereof. There is an inlet of the exhaust gas on the left side of the honeycomb structure 2, and the exhaust gas flows through the flowing cells 5 of the honeycomb structure 2 which are opened without being plugged. The exhaust gas which has flowed through the flowing cells 5 passes through the porous partition walls 6 to flow out of the other flowing cells. Moreover, when the exhaust gas passes through the partition walls 6, the particulates including the soot in the exhaust gas are trapped by the partition walls 6, and the exhaust gas can be purified.

Heretofore, such honeycomb structure 2 is manufactured by adding water to a main material including a ceramic material and an organic binder to knead the material into a clay; extruding this clay from an extrusion form into the honeycomb structure; and drying and firing the structure. In a case where low-plasticity particles of the ceramic material or the like are used in manufacturing such honeycomb structure, low plasticity causes a problem that combining of honeycomb structure intersections under pressure becomes insufficient. It is to be noted that the combining of the intersections under pressure refers to a clay combining phenomenon in which when the raw material is extruded from the extrusion form, the material flows from grooves of the extrusion form of four directions of left, right, upper and lower directions, and is combined in one point.

In a case where in the DPF, there is used a honeycomb structure having a state in which the combining of the intersections under pressure is insufficient, defects are clearly detected in an inspection such as laser smoke, and cell cuts are actually recognized. In this manner, the low plasticity of the clay is a cause for a drop of yield.

On the other hand, in the DPF, pressure losses need to be reduced from a viewpoint of reduction of engine fuel consumption. For this purpose, there is a demand for enhancement of porosity of the honeycomb structure which is a substrate constituting the DPF (the porosity in the honeycomb structure be increased). To meet such demand, it is disclosed that a solid pore former such as starch or a hollow pore former such as a foamed resin is used as a pore former (see Patent Document 1).

Moreover, there is disclosed a method of manufacturing a porous material for use as a catalyst carrier, a synthesizing place of various types of compounds or the like (see Patent. Document 2). This manufacturing method includes mixing ceramic powder, an inorganic binder and a high-absorption resin; extruding the resultant mixture into a formed body; and heating and firing the above formed body. In this case, the high-absorption resin has an average particle diameter of 10 to 70 μm before water is absorbed, and an average particle diameter of several hundreds of micrometers after water has been absorbed. A water absorbing magnification is 100 to several hundreds of folds.

Furthermore, there is disclosed a method of manufacturing a porous ceramic for use in a sensor element, a catalyst carrier, an incombustible construction material, a heat insulating material, a sound insulating material, a shock absorbing material or the like (see Patent Document 3). This manufacturing method includes a step of allowing fine particles of a water expansive absorption resin to absorb water and forming the particles into a gel having a gel strength of 10,000 dynes/cm² or more; a step of mixing the gel which has absorbed water and the ceramic powder to form a formed body; and a step of firing the formed body. This method obtains the porous ceramic having a porosity of 40% or more; and a bending strength which is 15% or more of a bending strength of a dense ceramic containing the same component. In this manufacturing method, the water expansive absorption resin has a water absorption of 100 to 1,000 g/g (water absorbing magnification of 100 to 1,000 folds) with respect to pure water, and any water content is not added besides water absorbed by the water absorption resin.

[Patent Document 1] Japanese Patent Application Laid-Open No. 2001-373986;

[Patent Document 2] Japanese Patent Application Laid-Open No. 11-71188; and

[Patent Document 3] Japanese Patent Application Laid-Open No. 10-167856.

However, in the manufacturing method disclosed in Patent Document 1, there is a disadvantage when an amount of starch to be added is set to be a certain amount or more, an excessive temperature gradient is generated in the honeycomb structure owing to heat generated by the combustion of starch during the heating for the degreasing, and cracks are generated in the honeycomb structure. On the other hand, to effectively use the foamed resin as the pore former, a clay density needs to be set to be low so that the foamed resin is inhibited from being crushed during the kneading of the raw material. However, in a case where the clay density is set to be low; the clay has a lowered hardness. This causes a disadvantage that the clay is largely deformed during the forming. Therefore, in a case where the only starch or foamed resin is used as the pore former, there is a problem that the yield drops, and a dimensional precision becomes insufficient.

Moreover, to be specific, the manufacturing method described in Patent Document 2 includes obtaining a pellet-like formed body by the extrusion; granulating this formed body to obtain a spherical formed body; and drying and firing this spherical formed body to thereby obtain a porous article. Since the granulation is performed after the extrusion, there is an advantage that product characteristics are not influenced by the presence of defects during the extrusion (formability during the extrusion). However, there is a problem that if this manufacturing method is applied to a honeycomb formed body, a low porosity of 40% or less is only obtained (see [Table 1] of Patent Document 2).

Furthermore, in the manufacturing method described in Patent Document 3, since an only small amount of organic binder is added as the binder, the plasticity of the clay is deteriorated. In a case where this method is applied to the honeycomb structure in which high plasticity is required, there is a problem that the yield is deteriorated.

### SUMMARY OF THE INVENTION

The present invention has been developed in view of the above problem, and an object is to provide a method of manufacturing a honeycomb structure in which any defect or deformation is not generated during forming into a honeycomb shape, and an amount of heat to be generated during degreasing can be reduced, so that it is possible to prevent cells from being cut, improve yield and dimensional precision, and reduce pressure losses.

To achieve the above object, according to the present invention, there is provided the following method of manufacturing a honeycomb structure.

[1] A method of manufacturing a honeycomb structure, comprising the steps of mixing and kneading a clay material including a ceramic material, a binder and water to obtain a clay; forming the resultant clay into a honeycomb shape to obtain a honeycomb formed body; and firing the resultant honeycomb formed body to obtain the honeycomb structure, wherein a material further including a water absorption resin is used as the clay material, an inorganic binder only is used as the binder included in the clay material, an organic binder is not substantially used, and the honeycomb structure having a porosity of 40% or more is obtained.

[2] The method of manufacturing the honeycomb structure according to the above [1], wherein as the water absorption resin included in the clay material, there is used a particulate resin having an average particle diameter after water absorption of 2 to 200 μm; and a water absorbing magnification of 2 to 100 folds.

[3] The method of manufacturing the honeycomb structure according to the above [1], wherein the water absorption resin is contained in the clay material at a ratio of 0.1 to 20 parts by mass with respect to 100 parts by mass of ceramic material.

[4] The method of manufacturing the honeycomb structure according to the above [1], wherein the water absorption resin is mixed and kneaded in a state in which a part of water is absorbed in the water absorption resin beforehand.

[5] The method of manufacturing the honeycomb structure according to the above [1], wherein the inorganic binder included in the clay material is at least one selected from the group consisting of pyrofilament-talc, smectite, vermiculite, mica, fragile mica and hydrotalcite.

[6] The method of manufacturing the honeycomb structure according to the above [1], wherein the inorganic binder is contained in the clay material at a ratio of 0.01 to 10 parts by mass with respect to 100 parts by mass of ceramic material.

[7] The method of manufacturing the honeycomb structure according to the above [1], wherein the ceramic material included in the clay material is a material containing, as a main component, at least one selected from the group consisting of a cordierite forming material, mullite, alumina, aluminum titanate, lithium aluminum silicate, silicon carbide, silicon nitride and metal silicon.

[8] The method of manufacturing the honeycomb structure according to the above [1], wherein the clay material contains water at a ratio in terms of parts by mass which is not less than a value (content ratio of the water absorption resin×water absorbing magnification) obtained by multiplying the content ratio of the water absorption resin by the water absorbing magnification with respect to 100 parts by mass of ceramic material.

[9] The method of manufacturing the honeycomb structure according to the above [1], wherein an oil-containing material is used as the clay material.

[10] The method of manufacturing the honeycomb structure according to the above [9], wherein the oil is at least one selected from the group consisting of soybean oil, sunflower oil, palm oil, corn oil, coconut oil, cotton seed oil, castor oil, peanut oil, essential oil, soybean fatty acid, beast oil, bacon grease, lard, fish oil, mineral oil, a mixture of light mineral oil and wax emulsion and paraffin wax mixed in corn oil.

[11] The method of manufacturing the honeycomb structure according to the above [9], wherein the oil is contained in the clay material at a ratio of 2 to 30 parts by mass with respect to 100 parts by mass of ceramic material.

[12] The method of manufacturing the honeycomb structure according to the above [1], wherein a material including a pore former is used as the clay material.

In the present invention, the material including the water absorption resin is used as the clay material, the only inorganic binder is used as the binder included in the clay material, and the organic binder is not substantially used. This synergistically functions, so that the amount of heat to be heated during degreasing can be reduced without generating any defect or deformation during the forming into the honeycomb shape. Therefore, it is possible to produce a synergistic effect that the honeycomb structure can be manufactured in which the cells can be prevented from being cut, yield and dimensional precision can be improved, and pressure losses can be reduced. That is, the water absorption resin included in the clay absorbs water, a structure in which a water content is absorbed in the resin is obtained, the structure has a high mechanical strength, and the structure cannot be crushed easily. Therefore, the structure has a stabilized pore forming capability. Since a clay density can be set to be high, a clay hardness increases, and the deformation during the forming can remarkably be reduced. When the ceramic material and water are mixed and kneaded, the ceramic material and the water absorption resin are granulated. Therefore, plasticity of the clay is improved, and combining of intersections under pressure is sufficiently performed during the extrusion. In consequence, the defects can be inhibited from being generated. As the binder included in the clay, the only inorganic binder is used, and the organic binder is not substantially used. Therefore, during the degreasing, heat is prevented from being generated by combustion of the organic binder, and the cells can effectively be prevented from being cut. In consequence, the yield and the dimensional precision can be improved. Furthermore, the water absorption resin disappears during heating at a time when the binder is removed. This disappearance can generate pores having a porosity of 40% or more in the honeycomb structure. Since the high porosity of 40% or more is realized in this manner, the pressure losses can be reduced.

### BRIEF DESCRIPTION OF THE DRAWINGS

FIG. 1 is a perspective view showing one example of a honeycomb structure;

FIG. 2 is a sectional view cut along the A-A line of FIG. 1;

FIG. 3 is a perspective view showing one example of a DPF; and

FIG. 4 is a schematic explanatory view showing an inspection device of a soot print test.

### DESCRIPTION OF THE PREFERRED EMBODIMENT

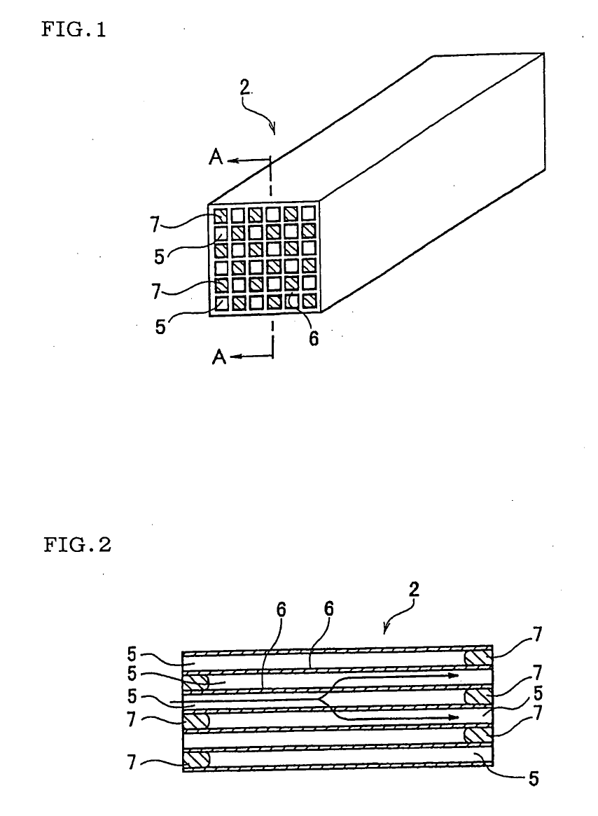

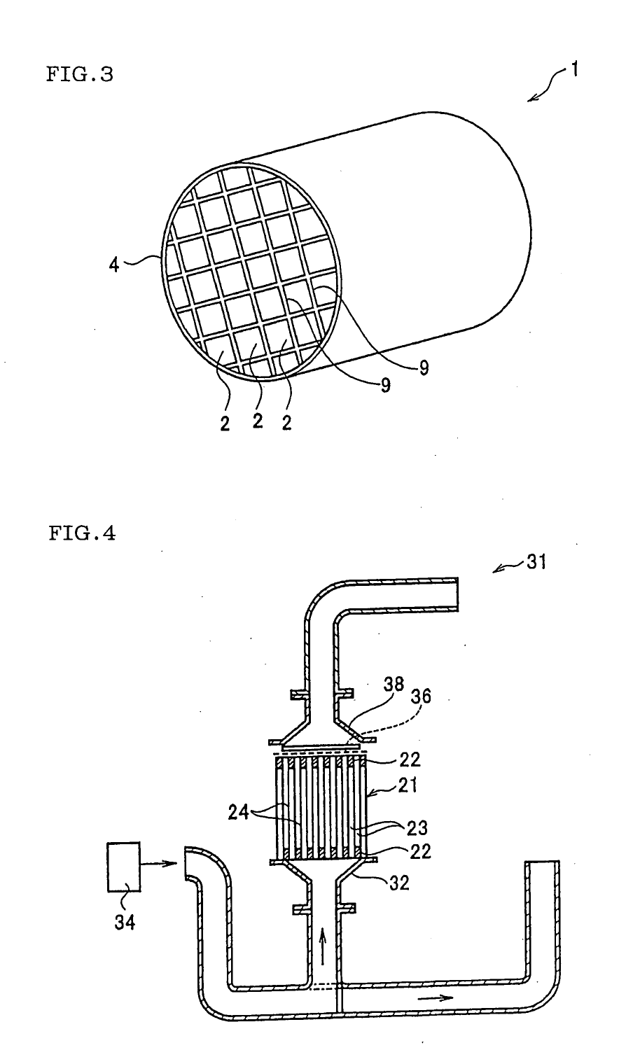

There will specifically be described hereinafter an embodiment of a method of manufacturing a honeycomb structure in the present invention. For example, FIGS. 1 and 2 show a honeycomb structure manufactured in the present embodiment, and as to an application of the structure, the structure is used in a filter such as a DPF shown in FIG. 3.

The method of manufacturing the honeycomb structure in the present embodiment is a manufacturing method including the steps of mixing and kneading a clay material including a ceramic material, a binder and water to obtain a clay; forming the resultant clay into a honeycomb shape to obtain a honeycomb formed body; and firing the resultant honeycomb formed body to obtain the honeycomb structure. A material further including a water absorption resin is used as the clay material, an inorganic binder only is used as the binder included in the clay material, an organic binder is not substantially used, and the honeycomb structure having a porosity of 40% or more is obtained. The method is roughly divided into “the step of mixing and kneading the clay material including the ceramic material, the inorganic binder, the water absorption resin and water to obtain the clay (first step)”, “the step of forming the resultant clay into the honeycomb shape to obtain the honeycomb formed body (second step)”, and “the step of firing the resultant honeycomb formed body to obtain the honeycomb structure having a porosity of 40% or more (third step)”. Each step will specifically be described hereinafter.

(First Step)

The first step of the present embodiment is a step of mixing and kneading the clay material including the ceramic material, the inorganic binder, the water absorption resin and water to obtain the clay as described above.

The “water absorption resin” for use in the present embodiment means a resin having a structure in which water is absorbed, and a water content is retained in the resin, when water is mixed and kneaded with the resin together with the ceramic material and the inorganic binder described later, the resin having a characteristic that a mechanical strength of the structure is high and the structure is not easily crushed. When mixed and kneaded, the water absorption resin and the ceramic material are granulated. Therefore, plasticity of the clay can be improved. In a case where in such state, the material is extruded into a honeycomb shape by use of an extrusion form to obtain the honeycomb formed body as described later in the second step, since combining of intersections under pressure is sufficiently performed, defects can be inhibited from being generated.

Preferable examples of the water absorption resin for use in the present embodiment can include a spherical water absorption resin obtained by reversed phase suspension polymerization of a vinyl monomer.

In the present embodiment, it is preferable to use, as the water absorption resin, a particulate resin having an average particle diameter of 2 to 200 μm after water has been absorbed. It is further preferable to use a resin having an average particle diameter of 2 to 100 μm. If the average particle diameter is less than 2 μm, the resin cannot sufficiently produce an effect of a plasticizer in some case. On the other hand, if the average particle diameter is above 200 μm, particle diameters are large as compared with another powder material for use in the clay. Therefore, dispersibility sometimes drops, the pores enlarge after the firing, and the defects of the honeycomb structure are generated in some case. In a case where the water absorption resin which has absorbed water has an average particle diameter of 2 to 200 μm, the resin has sufficient plasticity and dispersibility. Moreover, after the firing, the pores do not become larger than required. Therefore, the defects can be inhibited from being generated. It is to be noted that the water absorption resin described in Patent Document 2 described above has an average particle diameter of several hundreds of micrometers after water is absorbed. Therefore, this resin is clearly different from the water absorption resin of the present embodiment in the size of the average particle diameter after the water absorption.

Moreover, it is preferable to use the water absorption resin having a water absorbing magnification of 2 to 100 folds, and it is further preferable to use the resin having a water absorbing magnification of 2 to 50 folds. If the water absorbing magnification is less than 2 folds, the water absorption is small, and the plasticity is not improved in some case. If the water absorbing magnification is above 100 folds, the honeycomb formed body formed into the honeycomb shape contains much water. Therefore, a drying time lengthens. Moreover, much electric power for drying is required, and drying cost sometimes increases. Since hardness of the honeycomb formed body having the honeycomb shape drops, and drying ratio increases, the article is easily deformed, and the yield sometimes drops. Here, the drying ratio means an index indicating a degree of expansion or contraction before and after the drying, and the ratio can be obtained by (length before dried)/(length after dried). If the water absorbing magnification of the water absorption resin is in a range of 2 to 100 folds in this manner, the plasticity of the clay is improved, and the hardness is kept to be constant. Therefore, it is possible to obtain the honeycomb structure having a satisfactory formability and an excellent dimensional precision. It is to be noted that the water absorption resin described in Patent Document 2 described above has a water absorbing magnification of 100 to several hundreds of folds, and the water absorption resin described in Patent Document 3 has a water absorbing magnification of 100 to 1,000 folds. Both of these resins are clearly different from the water absorption resin of the present embodiment in size of the water absorbing magnification.

In the present embodiment, it is preferable to use, as the water absorption resin, a particulate resin having a particle size distribution after the water absorption, including 20 parts by mass or less of particles having an average particle diameter of 10 μm or less, and 20 parts by mass or less of particles having an average particle diameter of 100 μm or more. In the particle size distribution after the water absorption, if the particles having an average particle diameter of 10 μm or less are included above 20 parts by mass, the effect of the plasticizer cannot sufficiently be produced in some case. The resin enters gaps among ceramic material particles, and a pore forming capability drops in some case. If the particles having an average particle diameter of 100 μm or more are included above 20 parts by mass, the resin has a larger average particle diameter as compared with the other material. Therefore, the dispersibility of the water absorption resin sometimes drops. If the dispersibility of the water absorption resin drops, the water absorption resin aggregates in the clay, the pores formed by the water absorption resin enlarge after the firing, and the pores themselves sometimes constitute the defects. In a case where the particle size distribution of the water absorption resin which has absorbed water includes 20 parts by mass or less of the particles having an average particle diameter of 10 μm or less and 20 parts by mass or less of the particles having an average particle diameter of 100 μm or more, sufficient plasticity and dispersibility can be imparted to the clay. Moreover, since the pores after the firing do not enlarge more than necessary, the defects can be inhibited from being generated.

In the present embodiment, it is preferable to use, as the water absorption resin, a particulate resin having an average particle diameter after the water absorption which is 30% or less of a thickness of each partition wall of the honeycomb structure finally obtained in the third step. It is further preferable to use the resin having an average particle diameter of 20% or less. If the average particle diameter of the water absorption resin which has absorbed water is above 30% of the thickness of the partition wall, there is an increase of a ratio occupied by the pores formed by the water absorption resin after the firing in the thickness of the partition wall, and the pores themselves sometimes constitute the defects. In a case where the average particle diameter of the water absorption resin which has absorbed water is 30% or less of the thickness of the partition wall, the pores do not enlarge more than necessary after the firing. Therefore, the defects can be inhibited from being generated,

In the present embodiment, it is preferable to use, as the water absorption resin, a particulate resin having an aspect ratio after the water absorption of 50 or less, and it is further preferable to use the resin having the ratio which is 30 or less. In a case where the aspect ratio of the water absorption resin after the water absorption is above 50, when the material is formed into the honeycomb shape to obtain the honeycomb formed body, the water absorption resin is oriented, and the pores formed by the water absorption resin after the firing are formed in parallel with the partition walls. Therefore, the pores do not easily form communication holes, and the pressure losses sometimes increase. In a case where the aspect ratio of the water absorption resin after the water absorption is 50 or less, since the pores formed by the water absorption resin after the firing form the communication holes, the pressure losses can be reduced.

In the present embodiment, it is preferable to contain the water absorption resin at a ratio of 0.1 to 20 parts by mass with respect to 100 parts by mass of ceramic material, and it is further preferable to contain the resin at a ratio of 1 to 20 parts by mass with respect to 100 parts by mass of ceramic material. In this manner, it is preferable that a content of the water absorption resin in the clay material is set by correlation with the ceramic material. If the content of the water absorption resin is less than 0.1 part by mass with respect to 100 parts by mass of ceramic material, the content is small, the plasticity of the clay is not improved, and the yield sometimes drops. If the content is above 20 parts by mass, heat is largely generated during the firing, and cuts are sometimes generated in the honeycomb structure. In a case where the content of the water absorption resin is controlled in this manner, the amount of heat to be generated during the firing can be reduced in a state in which the plasticity of the clay is improved. This can prevent the cells from being cut, and the yield can be improved.

In the present embodiment, it is preferable to mix and knead the water absorption resin in a state in which the water absorption resin absorbs a part of water beforehand. When the water absorption resin absorbs water beforehand, a time for granulating the water absorption resin together with the ceramic material can be shortened. As a result, a kneading time can be shortened.

In the present embodiment, in a case where a cordierite forming material is used as the ceramic material described later, it is preferable to use, as the water absorption resin, a resin which does not contain an alkaline metal or an alkaline earth metal other than magnesium, aluminum and silicon. When the composition of the water absorption resin is controlled in this manner, it is possible to avoid mixture of the alkaline metal or the alkaline earth metal other than magnesium, aluminum and silicon, which is attributable to the water absorption resin. It is possible to avoid a thermal expansion abnormality of the honeycomb structure made of cordierite after the firing. If there occurs the mixture of the alkaline metal or the alkaline earth metal other than magnesium, aluminum and silicon, thermal expansion of the honeycomb structure made of cordierite after the firing increases.

In the present embodiment, it is preferable to use, as the water absorption resin, a resin in which a content of chlorine is 20 parts by mass or less with respect to 100 parts by mass of water absorption resin, and it is further preferable to use a resin which does not contain chlorine. When the content of chlorine in the water absorption resin is controlled in this manner, generation of dioxins during the firing can be inhibited in the third step described later. When dioxins are generated during the firing, a post treatment step is required, and therefore cost increases.

In the present embodiment, it is preferable to use, as the water absorption resin, a resin in which a content of sulfur is 20 parts by mass or less with respect to 100 parts by mass of water absorption resin, and it is further preferable to use the resin which does not contain sulfur. When the content of sulfur in the water absorption resin is controlled in this manner, it is possible to inhibit generation of a toxic gas such as SOx gases or an H₂SO₄ gas during the firing in the third step described later. When the toxic gas is generated during the firing, a post-treatment step such as a desulfurization device is required, and cost increases.

In the present embodiment, it is preferable to use, as the water absorption resin, a resin in which a content of nitrogen is 20 parts by mass or less with respect to 100 parts by mass of water absorption resin, and it is further preferable to use the resin which does not contain nitrogen. When the content of nitrogen in the water absorption resin is controlled in this manner, it is possible to inhibit the generation of a toxic gas such as NOx gases, an HNO₃ gas or an NH₃ gas during the firing in the third step described later. When the toxic gas is generated during the firing, a post-treatment step such as a denitration device is required, and cost increases.

In the present embodiment, it is preferable to use, as the water absorption resin, a resin which does not contain an alkaline metal, sulfur, chlorine or nitrogen, in a case where the honeycomb dried article is fired in an inactive atmosphere in the third step described later. According to such constitution, even if such substance flies and scatters, it is possible to prevent a kiln material of a firing kiln from being corroded or damaged.

In the present embodiment, as the binder included in the clay material, the only inorganic binder is used, and the organic binder is not substantially used. Here, “the organic binder is not substantially used” means that “the organic binder is only included to such an extent that the binder is regarded as impurities in the clay material”. Preferable examples of the inorganic binder for use in the present embodiment can include at least one selected from the group consisting of pyrofilament-talc, smectite, vermiculite, mica, fragile mica and hydrotalcite. Above all, smectite is further preferable from viewpoints of price and composition, and hydrotalcite and talc are further preferable from a viewpoint that the alkaline metal can be inhibited from being flied or scattered during the firing.

Moreover, it is preferable that the inorganic binder is contained in the clay material at a ratio of 0.01 to 10 parts by mass with respect to 100 parts by mass of ceramic material, and it is further preferable that the inorganic binder is contained at a ratio of 0.1 to 5 parts by mass with respect to 100 parts by mass of ceramic material. It is preferable that the content of the inorganic binder in the clay material is set by correlation with the ceramic material. If the content of the inorganic binder is less than 0.01 parts by mass with respect to 100 parts by mass of ceramic material, the plasticity of the clay drops, and cell cuts are generated owing to insufficient combining under pressure, or the cell cuts are generated in the honeycomb formed body during the degreasing. If the content is above 10 parts by mass, there is sometimes caused a drop of porosity attributable to firing contraction of the inorganic binder during the firing. When the content of the inorganic binder is controlled in this manner, it is possible to reduce the amount of heat to be generated during the firing in a case where the plasticity of the clay is improved. This can prevent the generation of the cell cuts, and the yield can be improved.

There is not any special restriction on the ceramic material for use in the present embodiment, as long as the material is a ceramic capable of forming a certain shape when fired or a substance forming a ceramic having a certain shape when fired, but it is preferable to use a material containing, as a main component, at least one selected from the group consisting of, for example, the cordierite forming material, mullite, alumina, aluminum titanate, lithium aluminum silicate, silicon carbide, silicon nitride and metal silicon. When such raw material is selected, even the fired honeycomb structure can retain a certain shape.

From a viewpoint of resistance to thermal shock, it is preferable to use a material containing the cordierite forming material as the main component. It is to be noted that the cordierite forming material means cordierite itself and/or a raw material which forms cordierite when fired. Examples of the raw material forming cordierite when fired include a material containing a predetermined ratio of component appropriately selectable from the group consisting of talc, kaolin, calcined kaolin, alumina, aluminum hydroxide and silica so that as a chemical composition, SiO₂ falls in a range of 42 to 56 parts by mass, Al₂O₃ falls in a range of 30 to 45 parts by mass and MgO falls in a range of 12 to 16 parts by mass. The main component means a component constituting 50 parts by mass or more, preferably 70 parts by mass or more, further preferably 80 parts by mass or more of the ceramic material.

From a viewpoint of heat resistance of the honeycomb structure, it is preferable to use, as the ceramic material, a material containing, as a main component, silicon carbide alone or silicon carbide and metal silicon or silicon nitride. In a case where the main components of the ceramic material are metal silicon (Si) and silicon carbide (SiC), an Si content is defined by a blending ratio of Si/(Si+SiC). If the Si content defined by this blending ratio is too small, an effect of addition of Si is not easily obtained. If the content is above 50 parts by mass, an effect of heat resistance or thermal conductivity cannot be easily obtained which is a characteristic of SiC. Therefore, the Si content is preferably 5 to 50 parts by mass, further preferably 10 to 40 parts by mass.

In the present embodiment, in a case where metal silicon is used as the ceramic material, it is preferable to perform degreasing on conditions at 500° C. or less within ten hours before the honeycomb dried article is fired in the third step described later. It is preferable that this treatment burns out carbon included in the water absorption resin. According to such constitution, carbonization of metal silicon can be avoided, and it is possible to control the composition of the fired honeycomb structure. To burn out the carbon content of the water absorption resin, in a case where the firing needs to be performed at 500° C. or more for ten hours or more, oxidation of metal silicon rapidly proceeds.

In the present embodiment, it is preferable that an amount of water to be mixed in terms of parts by mass is set to be not less than a value (amount of the water absorption resin to be mixed×water absorbing magnification) obtained by multiplying the amount of the water absorption resin to be mixed by the water absorbing magnification. When such amount of water to be mixed is set, the water absorption resin can be brought into a saturated water absorption state, and a water content for dissolving the inorganic binder can firmly be secured. In consequence, the plasticity and further the formability of the clay can be improved. Since the amount of water to be mixed is large, the porosity of the fired honeycomb structure can further be increased.

In the present embodiment, it is preferable to use, as the clay material, a material further including oil, because the deformation of the formed body is inhibited and the yield is improved while maintaining the plasticity of the clay. The formed body is inhibited from being deformed by reducing the amount of water to be mixed and increasing the hardness of the formed body. However, when the amount of water to be mixed is reduced, the plasticity of the clay drops, and the cell cuts are generated owing to the insufficient combining under pressure. When the oil is contained, the drop of the plasticity due to the reduction of the amount of water to be mixed is compensated, the hardness of the formed body can be raised, and the deformation can be inhibited.

Preferable examples of the oil can include at least one selected from the group consisting of soybean oil, sunflower oil, palm oil, corn oil, coconut oil, cotton seed oil, castor oil, peanut oil, essential oil, soybean fatty acid, beast oil, bacon grease, lard, fish oil, mineral oil, a mixture of light mineral oil and wax emulsion and paraffin wax mixed in corn oil. Above all, the mineral oil or the mixture of light mineral oil and wax emulsion is further preferable.

It is preferable that the oil is contained in the clay material at a ratio of 2 to 30 parts by mass with respect to 100 parts by mass of ceramic material, and it is further preferable that the oil is contained at a ratio of 5 to 15 parts by mass with respect to 100 parts by mass of ceramic material. It is preferable that the content of the oil in the clay material is set by the correlation with the ceramic material in this manner. If the content of the oil is less than 2 parts by mass with respect to 100 parts by mass of ceramic material, the plasticity sometimes drops. If the content is above 30 parts by mass, viscosity of the oil becomes dominant, the hardness of the formed body drops, and the article is sometimes largely deformed. When the content of the oil is controlled in this manner, it is possible to inhibit the deformation during the forming in a state in which the plasticity of the clay is improved. In consequence, it is possible to improve the dimensional precision and the yield while preventing the generation of the cell cuts.

In the present embodiment, it is preferable to use a material further including a pore former as the clay material. The water absorption resin itself functions as the pore former, but when the pore former is further added in addition to the water absorption resin, it is possible to further increase the porosity of the honeycomb structure. There is not any special restriction on the pore former, but examples of the pore former can include graphite, flour, starch, phenol resin, poly(methyl metaphosphate), polyethylene, polyethylene terephthalate, non-foamed resin, foamed resin, sirasu-balloon, and fly ash balloon. When the pore former is also used, it is possible to reduce the content of the water absorption resin. Therefore, the hardness of the clay increases, and the dimensional precision can be improved.

In the present embodiment, it is preferable to use green returning material as the clay material. Here, the green returning material means that there is used again, as the clay material, the material which has received a share load from a mixing kneader, a clay kneader, a die and the like through the first step of obtaining the clay and the second step of obtaining the honeycomb formed body. When the green returning material is used as the clay as described above, the yield of the raw material can be improved. Heretofore, the foamed resin or the like has been used as the pore former during the raising of the porosity of the honeycomb structure. Therefore, when the green returning material is used as the ceramic material, the pore forming capability of the clay drops owing to the share load. In addition, the porosity of the fired honeycomb structure drops. Therefore, it is difficult to use the green returning material as the clay. When the water absorption resin is used as the clay material as in the present embodiment, the water absorption resin has a high mechanical strength, and is not easily crushed. Therefore, even when the green returning material is used as the clay, the porosity does not fluctuate in the fired honeycomb structure. In this manner, the green returning material can be used as the clay. When the green returning material is used, the yield of the raw material can be improved.

In the present embodiment, it is preferable to use dried returning material as the clay material including the ceramic material, the inorganic binder and the water absorption resin. Here, the dried returning material means that there is used again, as the clay material, the material which has received the share load from the mixing kneader, the clay kneader, the die and the like and which has further been formed into a dried article in a drying step, and then pulverized through the first step of obtaining the clay and the second step of obtaining the honeycomb formed body, and drying this formed body. When the dried returning material is used as the clay material as described above, the yield of the raw material can be improved. Heretofore, the foamed resin, the non-foamed resin or the like has been used as the pore former during the raising of the porosity of the honeycomb structure. Therefore, when the dried returning material is used as the clay material, the water content of such resin flies and scatters, and the characteristic of the resin changes. Therefore, it is difficult to obtain a characteristic similar the characteristic of the clay material by use of the dried returning material. In a case where the material including the water absorption resin is used as the clay material as in the present embodiment, a water absorption reaction of the water absorption resin is a reversible reaction. Therefore, even if the water content once flies and scatters, the material can be allowed to absorb water again so as to exhibit the equivalent characteristic. Even when the material formed into the dried returning material is used as the clay material, the porosity does not fluctuate in the fired honeycomb structure. Therefore, when the dried returning material is used, the yield of the raw material can be improved.

(Second Step)

The second step in the present embodiment is the step of forming the clay obtained in the first step into the honeycomb shape to obtain the honeycomb formed body. This step also includes the drying of the resultant honeycomb formed body.

There is not any special restriction on a method of forming the clay into the honeycomb shape to obtain the honeycomb formed body, but examples of the method can include an extrusion method using an extrusion form. When the clay is extruded in this manner, it is possible to obtain the honeycomb formed body having a large number of flowing cells 5 defined by partition walls 6 and extending in an axial direction (see FIGS. 1 and 2).

There is not any special restriction on a method of drying the honeycomb formed body, and examples of the method can include hot air drying, microwave drying, dielectric drying, reduced pressure drying and vacuum drying. Above all, a drying method is preferable which is a combination of the hot air drying and the microwave drying or the dielectric drying because the whole article can quickly and uniformly be dried. A drying temperature of the hot air drying is preferably in a range of 80 to 150° C. because the article can quickly be dried.

(Third Step)

The third step in the present embodiment is a step of firing the honeycomb formed body (which is usually dried) obtained in the second step, and obtaining the honeycomb structure having a porosity of 40% or more.

There is not any special restriction on the method of firing the honeycomb dried article, but examples of the method can include firing in an oxidizing atmosphere, firing in a non-oxidizing atmosphere and firing in a reduced-pressure atmosphere. Since optimum firing conditions (firing temperature and firing atmosphere) differ with the ceramic material for use in the clay, the conditions cannot uniquely be determined, but appropriate firing temperature and atmosphere can appropriately be selected in accordance with the selected ceramic material. For example, in a case where an oxide-based material such as the cordierite forming material or mullite is used, it is usually preferable to fire the article in an outside air atmosphere. When the cordierite forming material is used, it is preferable to fire the article at a temperature of 1400° C. to 1440° C. In a case where the material is a non-oxide material such as silicon carbide or silicon nitride, it is preferable to fire the article in a non-oxidizing atmosphere of nitrogen, argon or the like. When silicon carbide is combined with metal silicon, it is preferable to fire the article at a temperature of 1400° C. to 1800° C. When silicon carbide is combined with silicon nitride or the like, it is preferable to fire the article at a temperature of 1550° C. to 1800° C. When silicon carbide particles are combined with one another, it is preferable to fire the article at a temperature of at least 1800° C. When metal silicon is fired in nitrogen, and silicon nitride is generated, it is preferable to fire the article at a temperature of 1200° C. to 1600° C.

Prior to such firing, the degreasing is preferably performed by the heating. The degreasing can be performed by heating the dried honeycomb formed body in, for example, the outside air atmosphere at about 400° C.

It is to be noted that in a case where metal silicon is used as the ceramic material as described above, in the third step, before firing the dried honeycomb formed body, it is preferable that the degreasing is performed on conditions at 500° C. or less within ten hours, and this treatment burns out carbon included in the water absorption resin. In a case where the dried honeycomb formed body is fired in the inactive atmosphere in the third step, it is preferable to use a resin which does not contain one or more selected from the group consisting of alkaline metal, sulfur, chlorine and nitrogen as the water absorption resin constituting the clay in the first.

### EXAMPLES

The present invention will be described hereinafter in more detail in accordance with examples, but the present invention is not limited to any of these examples.

### Examples 1 to 3, Comparative Examples 1 and 2

After SiC powder and metal Si powder as a ceramic material, smectite as an inorganic binder and a water absorption resin A as a water absorption resin were mixed, a surfactant and water were added to the resultant mixture to knead the mixture, and a plastic clay was prepared with a vacuum clay kneader. As the water absorption resin A, there was used a resin having a water absorbing magnification of 10 folds and an average particle diameter after water absorption of 50 μm. A blending ratio of these materials is shown in Table 1. It is to be noted that in Comparative Example 1, any water absorption resin A was not mixed. In Comparative Example 2, instead of smectite as the inorganic binder, there were used methyl cellulose and hydroxypropoxyl methyl cellulose which were organic binders.

After extruding this clay into a honeycomb shape, the resultant formed body was dried by use of microwave and hot air, and there was obtained a ceramic formed body formed into a honeycomb shape having a partition wall thickness of 310 μm; a cell density of 46.5 cells/cm² (300 cells/square inch); a square section with one side being 35 mm long; and a length of 152 mm. Moreover, perpendicularity, range and bend of the resultant ceramic formed body were measured, and a deformation degree was evaluated. Evaluation results are shown in Table 2.

As shown in Table 2, in Examples 1 to 3 in which the water absorption resin A was mixed, values of the perpendicularity, range and bend decreased as compared with Comparative Example 1 in which any water absorption resin was not mixed, and in an intermediate stage of the present invention, it was possible to confirm inhibition of deformation during the forming. In Comparative Example 2 in which the organic binder was used instead of the inorganic binder, the water absorption resin A was mixed in the same manner as in Examples 1 to 3. Therefore, the values of the perpendicularity, range and bend were equivalent.

Thereafter, one-end portions of adjacent flowing cells on opposite sides were plugged so that ends of the ceramic formed body had a checkered pattern, and the article was dried, degreased at about 400° C. in the outside air atmosphere, and then fired at about 1450° C. in an Ar inactive atmosphere to obtain a segment (honeycomb structure) of a honeycomb filter of Si combined SiC. The presence (generation frequency) of defects in the segment was inspected using laser smoke, and defect species were identified by visual check. The porosity was measured by mercury porosimetry. Measurement results are shown in Table 3.

In a case where the defects are generated in the fired segment in a DPF preparing step, the setting becomes defective, and becomes a cause for drop of yield. In Comparative Example 1 in which any water absorption resin was not mixed, and plasticity of the clay material was low, the yield was very low. Many of the defects were cell cuts due to insufficient combining under pressure, which was attributable to low plasticity. In Comparative Example 2 in which the organic binder was used instead of the inorganic binder, cell cuts were generated during the degreasing, and the yield was low. In Example 1 in which 0.5 part by mass of water absorption resin was mixed, the yield was rapidly improved. In Examples 2 and 3 in which the mixed amounts were 2 parts by mass and 10 parts by mass, respectively, the yield was further improved. It is to be noted that Table 3 shows the number of the cell cuts/the number of the defects and the yield due to the cell cults.

### Examples 4 to 9

These examples were similar to Example 1 except that, as shown in Table 4, there were used various water absorption resins (water absorption resins B, D, E, F, G and H) other than the water absorption resin A of Example 1. Moreover, perpendicularity, range and bend of the resultant ceramic formed body were measured, a degree of deformation was evaluated, and there were also evaluated the presence (generation frequency) of defects in segments, the number of cell cuts/the number of the defects, yield due to the cell cuts and porosity. Evaluation results and measurement results are shown in Table 4.

In Table 4, the water absorption resin B is a resin having a water absorbing magnification of one fold, the water absorption resin D is a resin having a water absorbing magnification of five folds, the water absorption resin E is a resin having a water absorbing magnification of five folds, the water absorption resin F is a resin having a water absorbing magnification of 50 folds, the water absorption resin G is a resin having a water absorbing magnification of 100 folds, and the water absorption resin H is a resin having a water absorbing magnification of 300 folds.

In Example 4 in which the water absorption resin B was used, the water absorbing magnification of the water absorption resin was low, plasticity was not largely improved, an effect of optimization of a shape was comparatively smaller than that of another example, and improvement was seen in the yield due to the cell cuts, but the yield was still low. A pore forming capability was comparatively low, and the porosity was 43% and comparatively low.

In Examples 6 and 7, the plasticity was improved, and the dimensional precision was improved, but the water absorption resin after the water absorption had a large average particle diameter. Therefore, the pores formed by the water absorption resin after the firing were comparatively large, they themselves constituted defects, the cell cuts were generated, and the yield slightly dropped. In Example 9, there was seen an effect of reduction of defects due to mixture of the water absorption resin. However, since the water absorbing magnification of the water absorption resin was large, the honeycomb structure had a low hardness, and was comparatively largely deformed. Moreover, drying cost slightly increased.

On the other hand, in Examples 5 and 8 in addition to the improvement of the yield, the values of perpendicularity, range and bend were reduced, and the dimensional precision was improved.

### Example 10

Example 10 was similar to Example 5 except that in addition to a water absorption resin D of Example 5, a mixture of light mineral oil and wax emulsion was mixed as oil. Evaluation results and measurement results are shown in Table 5. In the resultant-honeycomb structure of Example 10, values of perpendicularity, range and bend were reduced, and a dimensional precision was improved while preventing generation of cell cuts.

### Example 11

Example 11 was similar to Example 5 except that in addition to a water absorption resin D of Example 5, a pore former and starch were mixed. Evaluation results and measurement results are shown in Table 5. In the resultant honeycomb structure of Example 11, a dimensional precision was further improved.

TABLE 1

| | | | | Comparative | Comparative |
|---|---|---|---|---|---|
| | Example 1 | Example 2 | Example 3 | Example 1 | Example 2 |
| Segment No. | 1 | 2 | 3 | 4 | 5 |
| SiC powder blended amount | 80 | 80 | 80 | 80 | 80 |
| (parts by mass) | | | | | |
| Metal Si powder blended | 20 | 20 | 20 | 20 | 20 |
| amount | | | | | |
| (parts by mass) | | | | | |
| Pore former blended | 15 | 15 | 15 | 15 | 15 |
| amount | | | | | |
| (parts by mass) | | | | | |
| Water blended amount | 32 | 48 | 106 | 28 | 55 |
| (parts by mass) | | | | | |
| Water absorption resin | 0.5 | 2 | 10 | — | 2 |
| blended amount | | | | | |
| (parts by mass) | | | | | |
| Inorganic binder blended | 6 | 6 | 6 | 6 | — |
| amount | | | | | |
| (parts by mass) | | | | | |
| Organic binder blended | — | — | — | — | 15 |
| amount | | | | | |
| (parts by mass) | | | | | |
| Mixing and kneading time | 40 | 43 | 40 | 65 | 43 |
| (minutes) | | | | | |

TABLE 2

| | | | | Comparative | Comparative |
|---|---|---|---|---|---|
| | Example 1 | Example 2 | Example 3 | Example 1 | Example 2 |
| Segment No. | 1 | 2 | 3 | 4 | 5 |
| Perpendicularity (°) | 0.69 | 0.72 | 0.7 | 1.23 | 0.72 |
| Range (mm) | 0.33 | 0.4 | 0.53 | 0.9 | 0.37 |
| Bend (mm) | 0.39 | 0.27 | 0.4 | 0.56 | 0.39 |

TABLE 3

| | | | | Com- | Com- |
|---|---|---|---|---|---|
| | | | | parative | parative |
| | Example 1 | Example 2 | Example 3 | Example 1 | Example 2 |
| Segment No. | 1 | 2 | 3 | 4 | 5 |
| Porosity (%) | 53 | 59 | 66 | 52 | 58 |
| Defect | 7 | 1 | 3 | 83 | 85 |
| generation | | | | | |
| frequency | | | | | |
| in segment | | | | | |
| (n = 100) | | | | | |
| No. of cell | 6/7 | 0/1 | 2/3 | 77/83 | 78/85 |
| cuts/No. | | | | | |
| of defects | | | | | |
| Yield due | 94 | 100 | 98 | 23 | 22 |
| to cell | | | | | |
| cuts (%) | | | | | |

TABLE 4

| | Example 4 | Example 5 | Example 6 | Example 7 | Example 8 | Example 9 |
|---|---|---|---|---|---|---|
| Water absorption resin No. | B | D | E | F | G | H |
| Water absorbing | 1 | 5 | 5 | 50 | 100 | 300 |
| magnification | | | | | | |
| Average particle diameter | 1.7 | 150 | 250 | 300 | 100 | 150 |
| after water absorption (μm) | | | | | | |
| Perpendicularity (°) | 1.03 | 0.66 | 0.57 | 0.69 | 0.60 | 1.13 |
| Range (mm) | 0.67 | 0.45 | 0.42 | 0.48 | 0.43 | 0.82 |
| Bend (mm) | 0.43 | 0.24 | 0.41 | 0.44 | 0.41 | 0.57 |
| Porosity (%) | 43 | 53 | 56 | 64 | 66 | 69 |
| Defect generation frequency | 41 | 5 | 47 | 53 | 5 | 6 |
| in segment (n = 100) | | | | | | |
| No. of cell cuts/No. of | 41/41 | 4/5 | 42/45 | 52/53 | 2/5 | 3/6 |
| defects | | | | | | |
| Yield due to cell cuts (%) | 59 | 96 | 58 | 48 | 98 | 97 |

TABLE 5

| | Example 10 | Example 11 |
|---|---|---|
| Water absorption resin No. | D | D |
| Water absorbing magnification | 5 | 5 |
| Average particle diameter | 150 | 150 |
| after water absorption (μm) | | |
| Oil blended amount (parts by mass) | 8 | — |
| Pore former blended amount (parts by mass) | — | 5 |
| Perpendicularity (°) | 0.49 | 0.41 |
| Range (mm) | 0.33 | 0.30 |
| Bend (mm) | 0.19 | 0.15 |
| Porosity (%) | 52 | 53 |
| Defect generation frequency | 5 | 5 |
| in segment (n = 100) | | |
| No. of cell cuts/No. of defects | 5/5 | 5/6 |
| Yield due to cell cuts (%) | 95 | 96 |

A method of manufacturing a honeycomb structure in the present invention is effectively utilized in various types of industrial fields such as a diesel engine exhaust gas treatment device, a dust removing device and a water treatment device in which various types of filters are necessary.

What is claimed is:

1. A method of manufacturing a honeycomb structure, comprising the steps of:
mixing and kneading a clay material including a ceramic material, a binder and water to obtain a clay;
forming the resultant clay into a honeycomb shape to obtain a honeycomb formed body; and
firing the resultant honeycomb formed body to obtain the honeycomb structure,
wherein a material further including a water absorption resin is used as the clay material, an inorganic binder only is used as the binder included in the clay material, an organic binder is not substantially used, and the honeycomb structure having a porosity of 40% or more is obtained.

2. The method of manufacturing the honeycomb structure according to claim 1, wherein as the water absorption resin included in the clay material, there is used a particulate resin having an average particle diameter after water absorption of 2 to 200 μm; and a water absorbing magnification of 2 to 100 folds.

3. The method of manufacturing the honeycomb structure according to claim 1, wherein the water absorption resin is contained in the clay material at a ratio of 0.1 to 20 parts by mass with respect to 100 parts by mass of ceramic material.

4. The method of manufacturing the honeycomb structure according to claim 1, wherein the water absorption resin is mixed and kneaded in a state in which a part of water is absorbed by the water absorption resin beforehand.

5. The method of manufacturing the honeycomb structure according to claim 1, wherein the inorganic binder included in the clay material is at least one selected from the group consisting of pyrofilament-talc, smectite, vermiculite, mica, fragile mica and hydrotalcite.

6. The method of manufacturing the honeycomb structure according to claim 1, wherein the inorganic binder is contained in the clay material at a ratio of 0.01 to 10 parts by mass with respect to 100 parts by mass of ceramic material.

7. The method of manufacturing the honeycomb structure according to claim 1, wherein the ceramic material included in the clay material is a material containing, as a main component, at least one selected from the group consisting of a cordierite forming material, mullite, alumina, aluminum titanate, lithium aluminum silicate, silicon carbide, silicon nitride and metal silicon.

8. The method of manufacturing the honeycomb structure according to claim 1, wherein water is contained in the clay material at a ratio in terms of parts by mass which is not less than a value (content ratio of the water absorption resin×water absorbing magnification) obtained by multiplying the content ratio of the water absorption resin by the water absorbing magnification with respect to 100 parts by mass of ceramic material.

9. The method of manufacturing the honeycomb structure according to claim 1, wherein an oil-containing material is used as the clay material.

10. The method of manufacturing the honeycomb structure according to claim 9, wherein the oil is at least one selected from the group consisting of soybean oil, sunflower oil, palm oil, corn oil, coconut oil, cotton seed oil, castor oil, peanut oil, essential oil, soybean fatty acid, beast oil, bacon grease, lard, fish oil, mineral oil, a mixture of light mineral oil and wax emulsion and paraffin wax mixed in corn oil.

11. The method of manufacturing the honeycomb structure according to claim 9, wherein the oil is contained in the clay material at a ratio of 2 to 30 parts by mass with respect to 100 parts by mass of ceramic material.

12. The method of manufacturing the honeycomb structure according to claim 1, wherein a material including a pore former is used as the clay material.
